(19) United States
(12) Patent Application Publication
(10) Pub. No.: US 2026/0146642 A1
(43) Pub. Date: May 28, 2026

(54) FASTENER LATTICE SEAL

(71) Applicant: ILLINOIS TOOL WORKS INC., Glenview, IL (US)

(72) Inventor: Mark O. Lepper, Glenview, IL (US)

(21) Appl. No.: 19/120,340

(22) PCT Filed: Oct. 23, 2023
(86) PCT No.: PCT/US2023/077554

§ 371 Date: Apr. 11, 2025

Related U.S. Application Data
(60) Provisional application No. 63/418,654, filed on Oct. 24, 2022.

(51) Int. Cl. F16B 43/00; F16B 5/06; F16B 21/08

(52) U.S. Cl. CPC F16B 43/001; F16B 5/06; F16B 21/086

(57) ABSTRACT

Disclosed is a flexible seal to form a sealed connection between a first component and a second component via a fastener and an opening formed in the second component. The flexible seal includes a through-hole, a seal surface, and a lattice structure. The through-hole receives at least a portion of the fastener. The seal surface conforms to the second component and seals the opening. The lattice structure manages a seal formed between the seal surface and the second component.

### CROSS-REFERENCE

The present application claims the benefit under 35 U.S.C. § 119(e) of U.S. Provisional Ser. No. 63/418,654 , filed Oct. 24, 2022, and entitled “Fastener Lattice Seal,” the contents of which are hereby incorporated by reference.

### BACKGROUND

Automotive components require fastening techniques that are simple to manufacture and assemble. Further, fastening techniques should above all be reliable and efficient. In order to secure a secondary panel to a primary panel, a fastener may be used. In some examples, the fastener may include a seal to seal the opening in the secondary panel. The seal may be fabricated from a soft material that is different from the rigid material used to fabricate the fastener. Despite various advancements to date, it would nevertheless be desirable to provide a fastener having an improved seal.

### SUMMARY

The present disclosure relates generally to a fastening system to form a sealed connection between components, such as automotive panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate, respectively, disassembled and assembled side views of an example fastening system configured to form a connection between components in accordance with aspects of this disclosure.

FIG. 2a illustrates an isometric view of the fastener assembly in accordance with a first example.

FIG. 2b illustrates a cross-sectional side view of the fastener assembly taken along cutline A-A (FIG. 2a).

FIG. 2c illustrates a topside isometric view of the seal of FIG. 2a.

FIG. 2d illustrates an underside isometric view of the seal of FIG. 2a.

FIG. 2e illustrates a top plan view of the seal of FIG. 2a.

FIG. 2f illustrates a bottom plan view of the seal of FIG. 2a.

FIGS. 2g through 2j illustrate, respectively, first, second, third, and fourth side elevation views of the seal of FIG. 2a.

FIG. 3a illustrates an isometric view of the fastener assembly in accordance with a second example.

FIG. 3b illustrates a cross-sectional side view of the fastener assembly taken along cutline B-B (FIG. 3a).

FIG. 3c illustrates a topside isometric view of the seal of FIG. 3a.

FIG. 3d illustrates an underside isometric view of the seal of FIG. 3a.

FIG. 3e illustrates a top plan view of the seal of FIG. 3a.

FIG. 3f illustrates a bottom plan view of the seal of FIG. 3a.

FIGS. 3g through 3j illustrate, respectively, first, second, third, and fourth side elevation views of the seal of FIG. 3a.

FIG. 4a illustrates an isometric view of the fastener assembly in accordance with a third example.

FIG. 4b illustrates a cross-sectional side view of the fastener assembly taken along cutline C-C (FIG. 4a).

FIG. 4c illustrates a topside isometric view of the seal of FIG. 4a.

FIG. 4d illustrates an underside isometric view of the seal of FIG. 4a.

FIG. 4e illustrates a top plan view of the seal of FIG. 4a.

FIG. 4f illustrates a bottom plan view of the seal of FIG. 4a.

FIGS. 4g through 4j illustrate, respectively, first, second, third, and fourth side elevation views of the seal of FIG. 4a.

FIG. 5a illustrates an isometric view of the fastener assembly in accordance with a fourth example.

FIG. 5b illustrates a cross-sectional side view of the fastener assembly taken along cutline D-D (FIG. 5a).

FIG. 5c illustrates a topside isometric view of the seal of FIG. 5a.

FIG. 5d illustrates an underside isometric view of the seal of FIG. 5a.

FIG. 5e illustrates a top plan view of the seal of FIG. 5a.

FIG. 5f illustrates a bottom plan view of the seal of FIG. 5a.

FIGS. 5g through 5j illustrate, respectively, first, second, third, and fourth side elevation views of the seal of FIG. 5a.

FIG. 6 illustrates an example method of manufacturing and assembling the fastener assembly.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A fastener can be used to form a sealed connection between a first component and a second component, such as automotive panels. In one example, a flexible seal is provided to form a sealed connection between a first component and a second component via a fastener and an opening formed in the second component. The flexible seal comprises: a through-hole configured to receive at least a portion of the fastener; a seal surface configured to conform to the second component and to seal the opening; and a lattice structure configured to manage a seal formed between the seal surface and the second component.

In another example, a fastener assembly is provided to fastener assembly to form a sealed connection between a first component and a second component having an opening. The fastener assembly comprises: a fastener configured to retain the second component relative to the first component; and a flexible seal configured to couple to the fastener, wherein the flexible seal comprises a through-hole, a lattice structure, and a seal surface configured to conform to the second component 104 and to seal the opening.

In yet another example, a method of fabricating a flexible seal is provided to form a sealed connection between a first component and a second component via a fastener and an opening formed in the second component. The method comprises: loading a 3D model to a 3D printer for processing by the 3D printer, wherein the 3D model specifies the flexible seal as having a through-hole configured to receive at least a portion of the fastener, a seal surface configured to conform to the second component 104 and to seal the opening, and a lattice structure configured to manage a seal formed between the seal surface and the second component; and manufacturing, via the 3D printer based on the 3D model, a flexible seal using a thermoplastic elastomer (TPE), a thermoplastic vulcanisate (TPV), or a thermoplastic polyurethane (TPU).

In some examples, the lattice structure comprises a plurality of struts. Each of the plurality of struts may be linear and may reside in a single plane. In some examples, the lattice structure comprises a first plurality of struts that resides in a single plane and a second plurality of struts, wherein each of the second plurality of struts is transverse to the single plane. The second plurality of struts can be arranged at an outer circumference of the flexible seal and configured to manage compressive loads of the flexible seal. The second plurality of struts can be arranged to define a truss. In some examples, the lattice structure comprises a plurality of struts arranged at an outer circumference of the flexible seal and configured to manage compressive loads of the flexible seal. In some examples, the lattice structure is formed on a surface opposite the seal surface. In some examples, the seal surface is a generally concave seal surface. In some examples, the flexible seal is an annular structure.

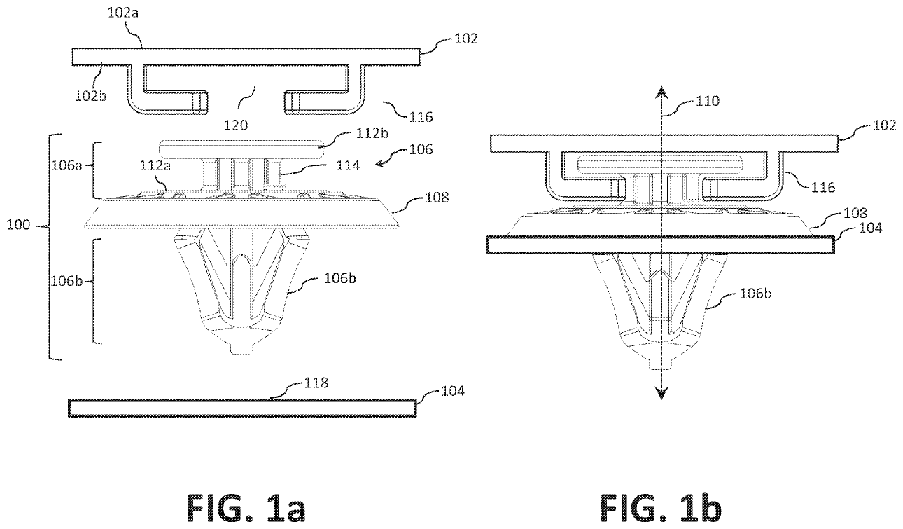

FIGS. 1a and 1b illustrate side views of an example fastener assembly 100 configured to form a connection between a first component 102 and a second component 104. The first component 102 and the second component 104 may be, for example, automotive panels. Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 102 include, without limitation, door trim panels, moldings, trim pieces, and other substrates (whether used as interior or exterior surfaces).

The first component 102 may define an A-surface 102a and a B-surface 102b (illustrated as an undersurface). The A-surface 102a, also called a class A surface, is typically the surface that is visible after assembly and, for that reason, is more aesthetically pleasing (e.g., textured, coated, or otherwise decorated) and typically free of attachment devices and/or related features. Conversely, the B-surface 102b, also called a class B surface, is typically the surface that is not visible after assembly and typically includes various attachment devices and/or related features. In the illustrated example, the first component 102 defines a doghouse feature 116, while the second component 104 defines an opening 118.

As illustrated in Figure la, the fastener assembly 100 generally comprises a fastener 106 and a flexible seal 108. The fastener 106 is rigid component that generally defines a head portion 106a and a retention portion 106b that defines a center axis 110. The opening 118 formed in the second component 104 may be generally circular and define a size and shape that is complementary to that of the retention portion 106b such that the retention portion 106b can be inserted and retained therein. However, openings of other shapes are contemplated.

The head portion 106a is configured to engage or otherwise attach to the first component 102. In the illustrated example, the head portion 106a generally defines a set of spaced-apart planar components (illustrated as first disk 112a and a second disk 112b) separated by a spacer 114. During assembly, a portion of the head portion 106a can be slipped into a cavity 120 defined by the doghouse feature 116. For example, the first disk 112a and the second disk 112b are sized and shaped such that the second disk 112b to fits in the cavity 120.

The retention portion 106b is configured to engage or otherwise attach to the second component 104. The retention portion 106b is configured to attach to the second component 104, embed in the second component 104, or pass through at least a portion of the second component 104 (e.g., via the opening 118). The second component 104 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Upon assembly, as best illustrated in FIG. 1b, the second component 104 is covered at least partially by the first component 102.

In the illustrated examples, the fastener assembly 100 is configured as a clip fastener with a flexible seal 108 attached thereto. While the present disclosure will be generally described in connection with a clip fastener, the teachings of the present disclosure, such as those directed to the flexible seal 108, may be applied to other types of fasteners where a seal is desired, including, for example, push pin fasteners, tree fasteners, a box-prong fastener, pin and grommet (P&G), specialty fasteners (e.g., a CenterLok™ fastener, which is available from Deltar®), etc. Finally, while only a single fastener assembly 100 illustrated in the examples, it should be appreciated that multiple fastening assemblies 100 may be used to couple a first component 102 to a second component 104, depending on the number of fastener points needed between the first and second components 102, 104. For example, larger panels typically require multiple fastener points.

As illustrated, the fastener 106 is attached to the B-surface 102b and, depending on the material type, may be attached to the B-surface 102b after fabrication of the first component 102 (e.g., using adhesive or an mechanical attachment method, such as the illustrated doghouse feature 116). While illustrated as configured for use with the doghouse feature 116, the doghouse feature 116, the second disk 112b, and/or the spacer 114 could be omitted and the fastener 106, or portion thereof, can be attached to or integrated with the first component via another means. For example, the head portion 106a can be adhesively secured to the first component 102. In another example, the first component 102 and the fastener 106 may be formed as a unitary structure.

In some examples, the first component 102 and the fastener 106 may be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the fastener 106 may be fabricated with the first component 102 using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the first component 102 and the fastener 106 may be formed or otherwise fabricated at different resolutions during a printing operation. For example, the fastener 106 portion may be printed at a higher resolution than that of the first component 102 or vice versa as needed for a particular application.

While it is contemplated that the first component 102 and the fastener 106 could be formed during the same printing session (i.e., printed during the same printing operation), it is possible that the fastener 106 may be printed onto a preexisting first component 102. For example, the first component 102 may be printed with one or more landmark structures (e.g., a protrusion or a recess) during a first session that can be located and filled and/or surrounded with material during a second session to form the fastener 106.

When assembled, the flexible seal 108 is positioned between the first and second components 102, 104 and used to mitigate dust, dirt, and/or moisture penetration through the opening 118. As will be described in connection with the following examples, the flexible seal 108 may be embodied as a ring (e.g., an annular structure) and fabricated from foam material, thermoplastic, rubber, etc. For example, as illustrated, a flexible seal 108 can be configured to fit over the distal end of the fastener 106 to surround a portion of the fastener 106 (e.g., at the base of the retention portion 106b and adjacent the first disk 112a) between the first component 102 and the second component 104.

The flexible seal 108 can be fixedly or removably attached to the fastener 106. For example, the flexible seal 108 can be slipped over the retention portion 106b and slid into place to abut a portion of the head portion 106a. In some examples, the fastener 106 may include additional features, such as ribs and wings to mitigate noise and/or rattle between the first and second components 102, 104.

The flexible seal 108 is fabricated using additive manufacturing techniques from a material that is different than that of the rigid fastener 106. That is, some materials are more conducive for sealing than mechanical attachment. In some examples, the seal material may be a soft, pliable, and/or conformable material, such as an elastomeric material, foam, etc. Example elastomeric materials include thermoplastic elastomer (TPE), thermoplastic vulcanisate (TPV), thermoplastic polyurethane (TPU), and the like. As explained previously, additive manufacturing techniques can be used to manufacture the flexible seal 108 with complex and/or precise features that serve to better seal the opening 118. As will be described, the flexible seal 108 can be embodied in one of multiple examples.

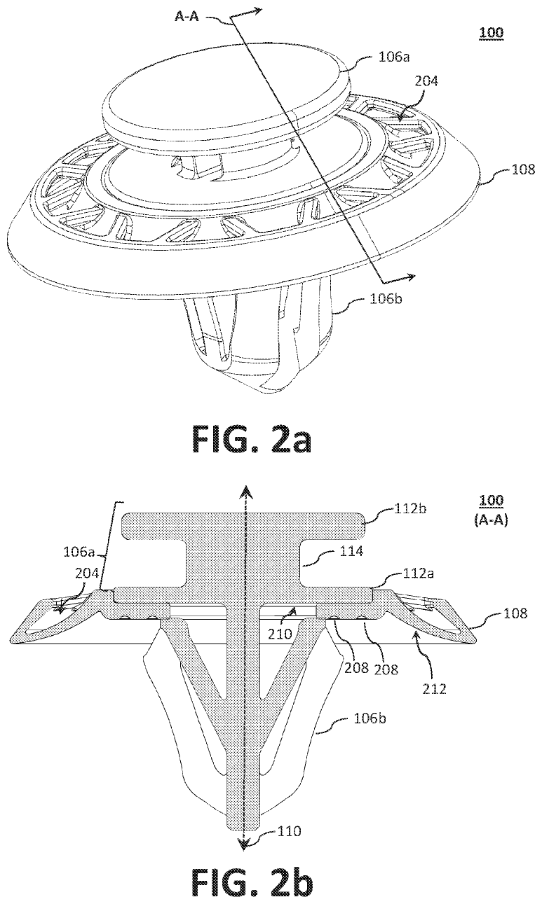

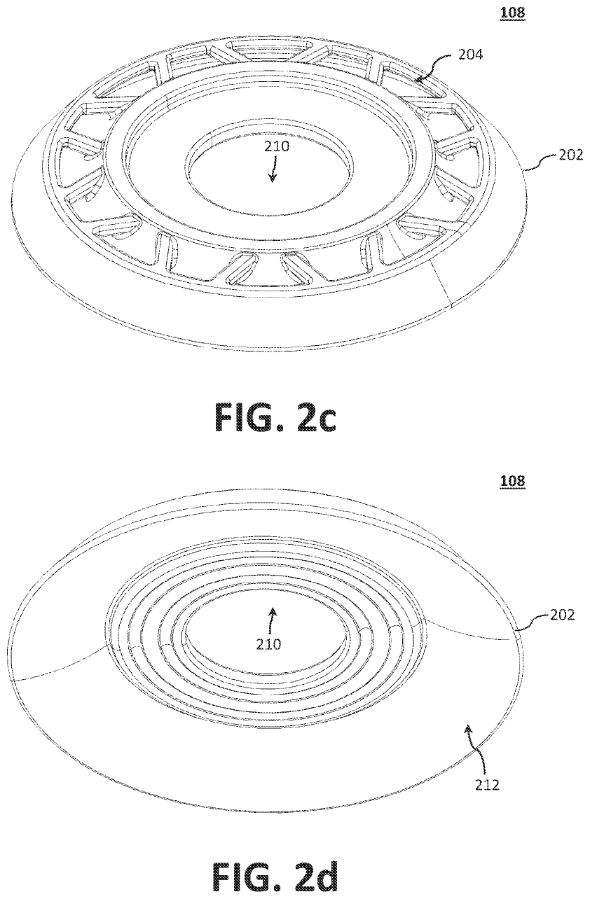

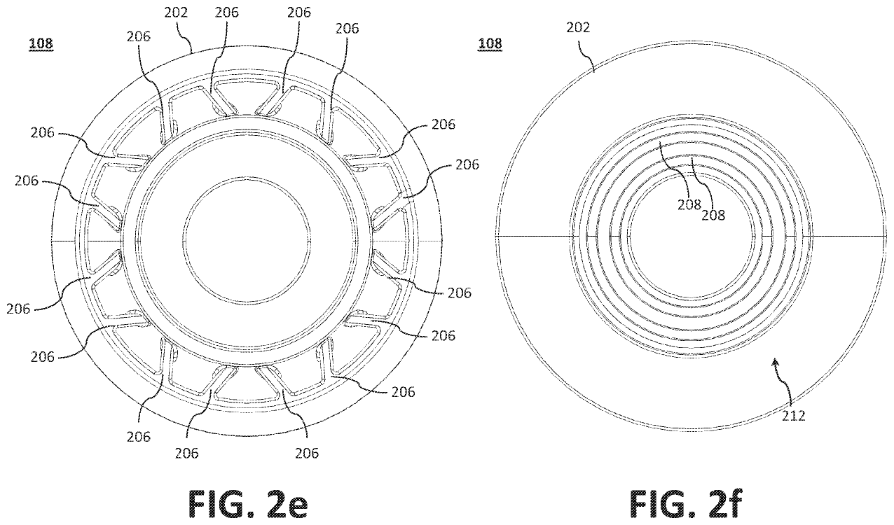

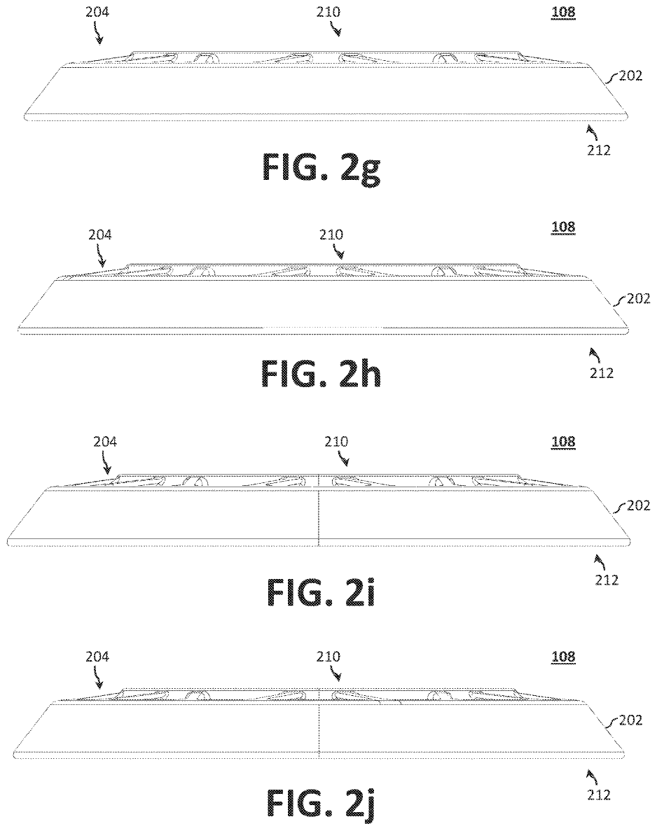

FIG. 2a illustrates an isometric view of the fastener assembly 100 in accordance with a first example, while FIG. 2b illustrates a cross-sectional side view thereof taken along cutline A-A (FIG. 2a). As explained previously, the fastener 106 is a rigid component that generally defines a head portion 106a and a retention portion 106b with a flexible seal 108 attached thereto. FIGS. 2c and 2d illustrate, respectively, topside and underside isometric views of the flexible seal 108 of FIG. 2a. FIGS. 2e and 2f illustrate, respectively, top and bottom plan views of the flexible seal 108. FIGS. 2g through 2j illustrate, respectively, first, second, third, and fourth side elevation views of the flexible seal 108 of FIG. 2a.

The flexible seal 108 is illustrated as an annular structure 202 configured to conform to a surface of the second component 104 and to seal the opening 118. In this example, the outer diameter of the annular structure 202 is substantially larger than the head portion 106a, thus enhancing the seal by increasing the surface area contact between the annular structure 202 and the second panel 104.

As illustrated, the annular structure 202 includes a through-hole 210 at its center and defines a cavity with a seal surface 212 along or adjacent a perimeter of the annular structure 202 (i.e., on the side that faces and contacts the second component 104). In the illustrated example, the seal surface 212 is angled to define a generally concave surface or cavity (e.g., a conical frustum). Thus, the seal surface 212 may be, for example, a conical or curved profile. The through-hole 210 is sized and shaped such that the retention portion 106b can pass at least partially therethrough. In the illustrated example, as best illustrated in FIG. 2b, the portion of the annular structure 202 adjacent the through-hole 210 is sized and shaped (e.g., planar and recessed) to accommodate and/or receive the first disk 112a. As a result, the first disk 112a can be substantially flush with outer portion of the annular structure 202. A plurality of concentric recessed rings 208 are provided opposite the first disk 112a on the portion of the annular structure 202 adjacent the through-hole 210.

A lattice structure 204 is formed in or on the annular structure 202 opposite the seal surface 212. The lattice structure 204 is configured to optimize sealing, compressibility, and mass of the flexible seal 108. While the flexible seal 108 is fabricated as a unitary structure, the lattice structure 204 may be printed at a higher resolution than that of the remainder of the flexible seal 108, if desired. As illustrated, the lattice structure 204 comprises a plurality of struts 206 oriented in different directions outwardly from the center axis 110 to manage compression and tension load.

As best illustrated in FIG. 2e, each of the plurality of struts 206 is substantially linear and adjacent pairs of struts 206 within the plurality of struts 206 are non-parallel. In the illustrated example, adjacent pairs of struts 206 are transverse to one another. In some examples, adjacent pairs of struts 206 are positioned relative to one another at an angle that is between 30 and 90 degrees. In the illustrated example, pairs of adjacent struts 206 alternate between about 30 and about 90 degrees relative to one another. While the plurality of struts 206 are illustrated as having the same thickness, in some examples the plurality of struts 206 may be of varying thicknesses. In some examples, the plurality of struts 206 is arranged to form a truss structure or a woven pattern. The plurality of struts 206 can vary in thickness and can be designed to deform under specific loading. The size and distribution of the plurality of struts 206 can therefore be adjusted to provide a desired distribution.

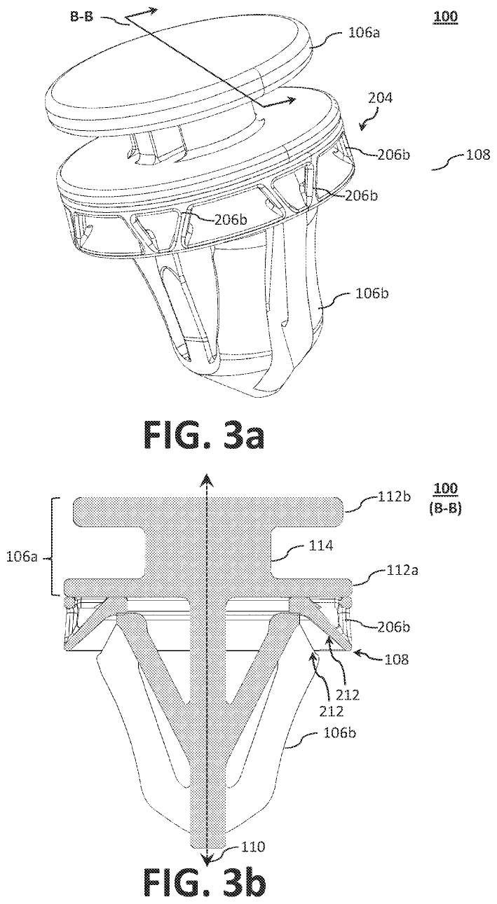

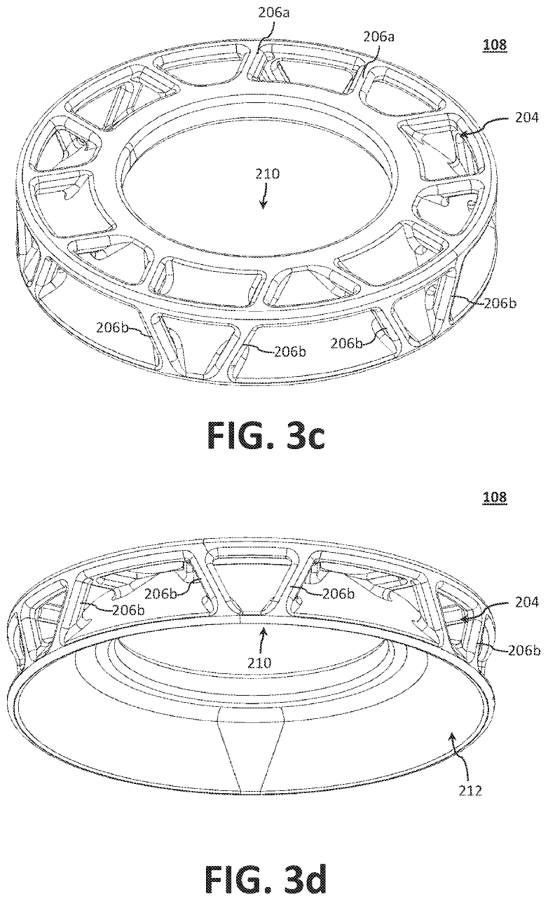

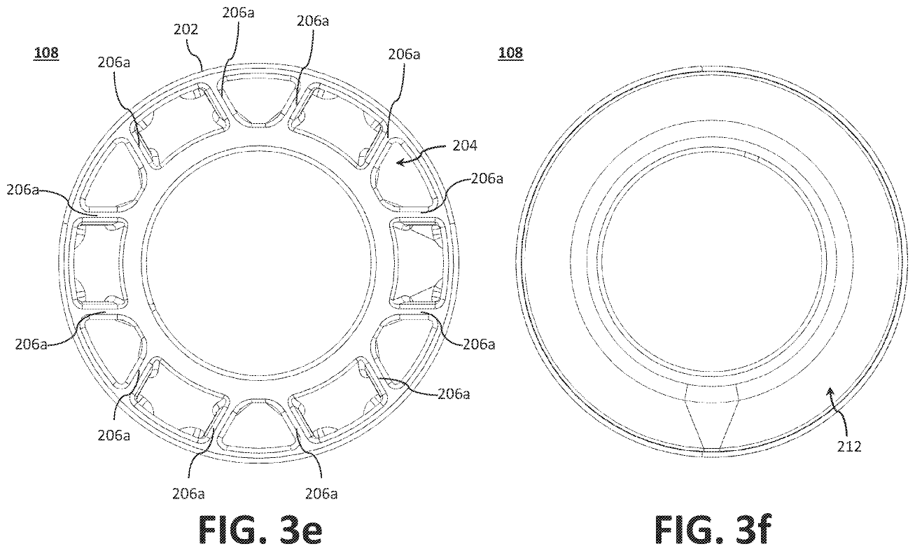

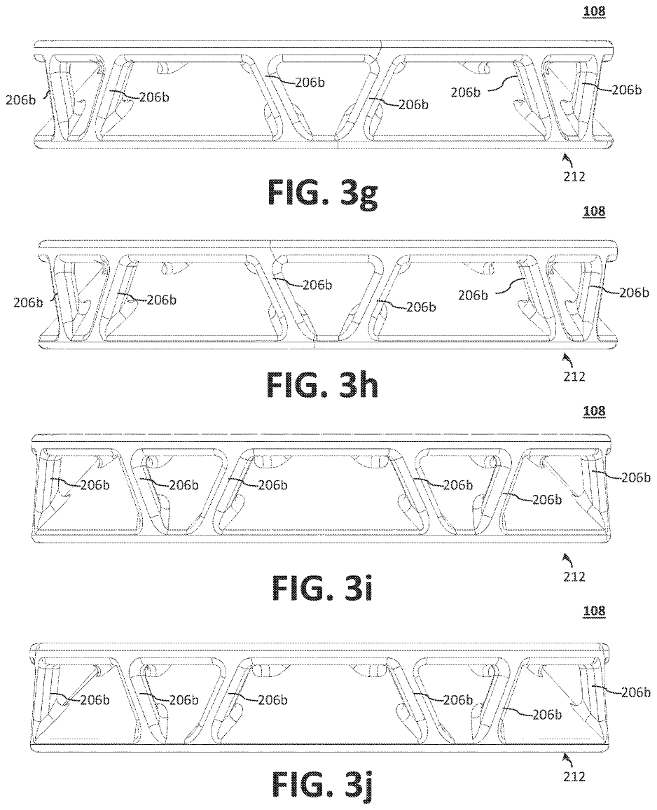

FIG. 3a illustrates an isometric view of the fastener assembly 100 in accordance with a second example, while FIG. 3b illustrates a cross-sectional side view thereof taken along cutline B-B (FIG. 3a). FIGS. 3c and 3d illustrate, respectively, topside and underside isometric views of the flexible seal 108 of FIG. 3a. FIGS. 3e and 3f illustrate, respectively, top and bottom plan views of the flexible seal 108. FIGS. 3g through 3j illustrate, respectively, first, second, third, and fourth side elevation views of the flexible seal 108 of FIG. 3a.

The flexible seal 108 according to the second example of FIGS. 3a through 3j is similar to the flexible seal 108 according to the first example of FIGS. 2a through 2j with a few exceptions.

First, unlike the flexible seal 108 of FIGS. 2a through 2j, in this example, the outer diameter of the annular structure 202 is substantially equal to that of the head portion 106a, thus resulting in a more compact fastener assembly 100. To that end, as best illustrated in FIG. 3b, the plurality of struts 206 and seal surface 212 are positioned adjacent the through-hole 210 such that the plurality of struts 206 and seal surface 212 are sandwiched between the head portion 106a and the second component 104 when assembled.

Second, whereas the flexible seal 108 of FIGS. 2a through 2j used a plurality of struts 206 that reside substantially in the same plane (i.e., a plane that is substantially parallel to a plane defined by a surface of the second component 104 at the opening), the flexible seal 108 of FIGS. 3a through 3j use a plurality of struts 206 that are arranged in different planes. For example, as best illustrated in FIG. 3c, the plurality of struts 206 comprise a plurality of generally horizontal struts 206a (e.g., a first plurality of struts) and a plurality of generally vertical struts 206b (e.g., a second plurality of struts).

The plurality of horizontal struts 206a are arranged in the same plane (i.e., a horizontal plane) in substantially the same manner as the plurality of struts 206 described in connection with FIGS. 2a through 2j. The plurality of generally vertical struts 206b, however, are arranged at the outer circumference of the flexible seal 108 and serve to manage compressive loads along the outermost edge of the seal surface 212.

As best illustrated in FIGS. 3g through 3j, the generally vertical struts 206b can be arranged to define a truss. In the illustrated example, the generally vertical struts 206b are positioned relative to the horizontal plane defined by the horizontal struts 206a at an angle that is between 30 and 60 degrees. While the plurality of generally vertical struts 206b are illustrated as having the same thickness, in some examples the plurality of generally vertical struts 206b may be of varying thicknesses. In some examples, the plurality of generally vertical struts 206b is arranged to form a truss structure or a woven pattern.

The plurality of generally vertical struts 206b can vary in thickness and can be designed to deform under specific loading. The size and distribution of the plurality of generally vertical struts 206b can therefore be adjusted to provide a desired distribution.

When assembled, the plurality of generally vertical struts 206b are configured to manage compressive loads between the head portion 106a (e.g., via the first disk 112a) against the second component 104 via the edge of the seal surface 212.

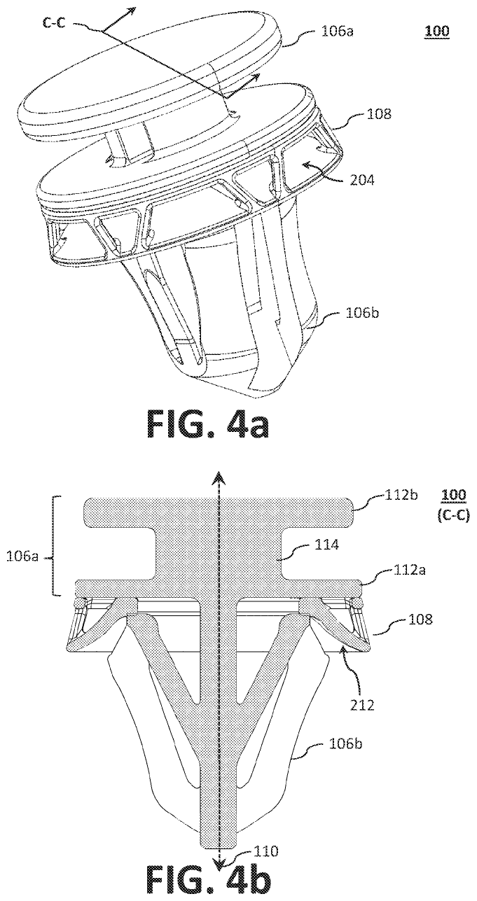

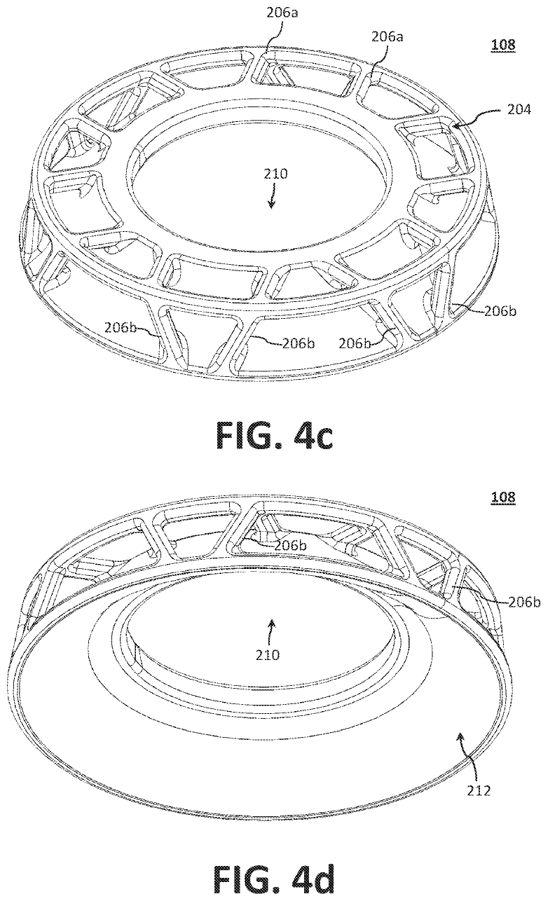

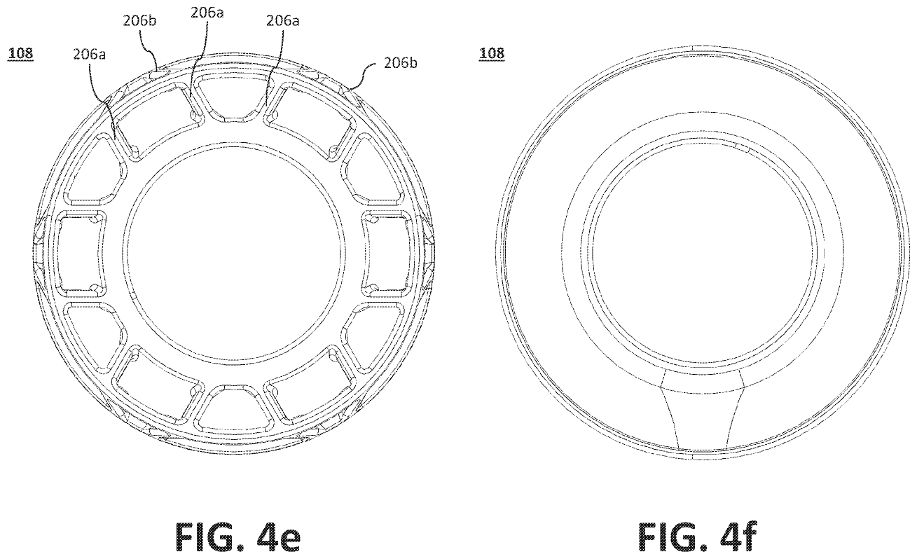

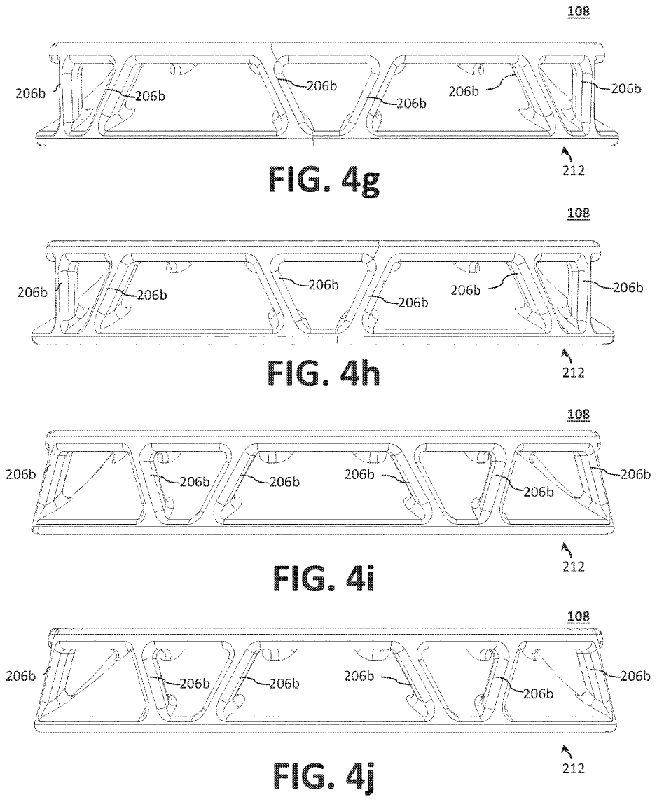

FIG. 4a illustrates an isometric view of the fastener assembly 100 in accordance with a third example, while FIG. 4b illustrates a cross-sectional side view thereof taken along cutline C-C (FIG. 4a). FIGS. 4c and 4d illustrate, respectively, topside and underside isometric views of the flexible seal 108 of FIG. 4a. FIGS. 4e and 4f illustrate, respectively, top and bottom plan views of the flexible seal 108. FIGS. 4g through 4j illustrate, respectively, first, second, third, and fourth side elevation views of the flexible seal 108 of FIG. 4a.

The flexible seal 108 according to the third example of FIGS. 4a through 4j is substantially the same as the flexible seal 108 according to the second example of FIGS. 3a through 3j except that the plurality of generally vertical struts 206b are flared outwardly from the center axis 110 such that the outer diameter of the annular structure 202 is slightly larger at its base than the head portion 106a, thus enhancing the seal by increasing the surface area contact between the annular structure 202 and the second panel 104. For example, as best illustrated in FIGS. 3g through 3j, the flexible seal 108 is shaped to generally define a conical frustum where the diameter of the base is greater than the diameter of the top, which is, in this example, substantially equal in diameter to the diameter of the head portion 116a.

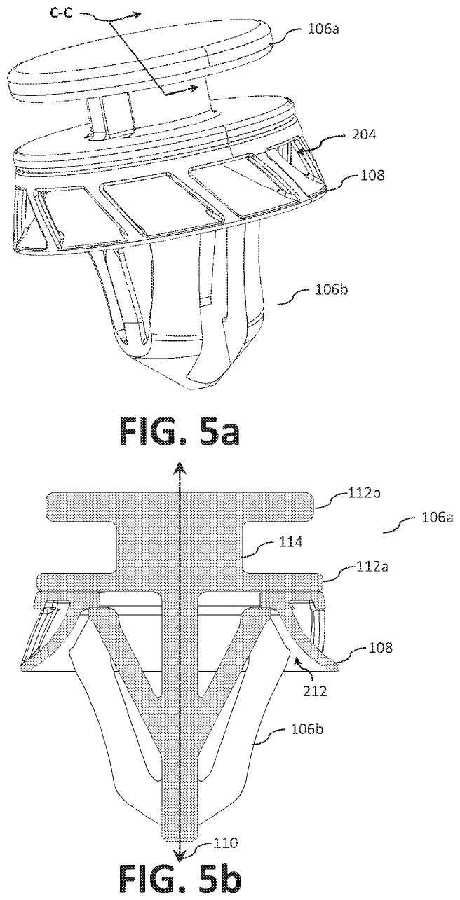

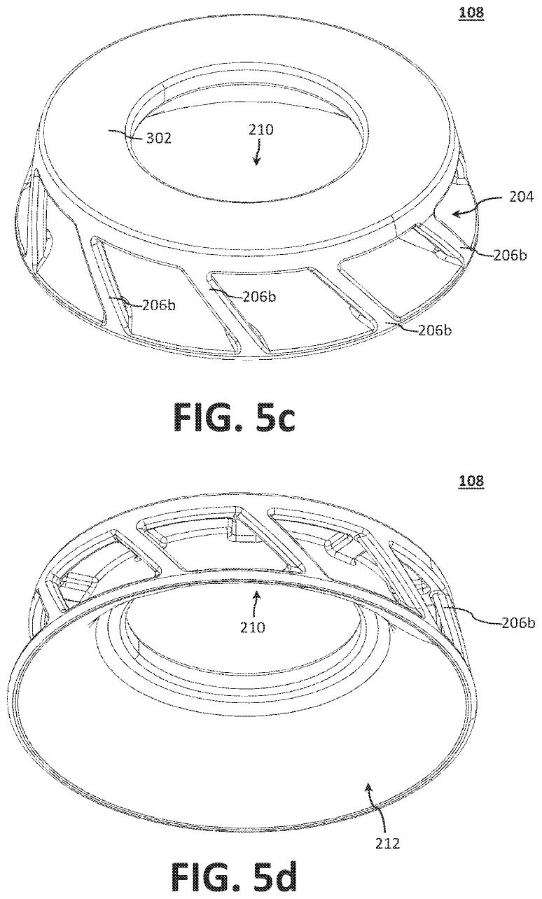

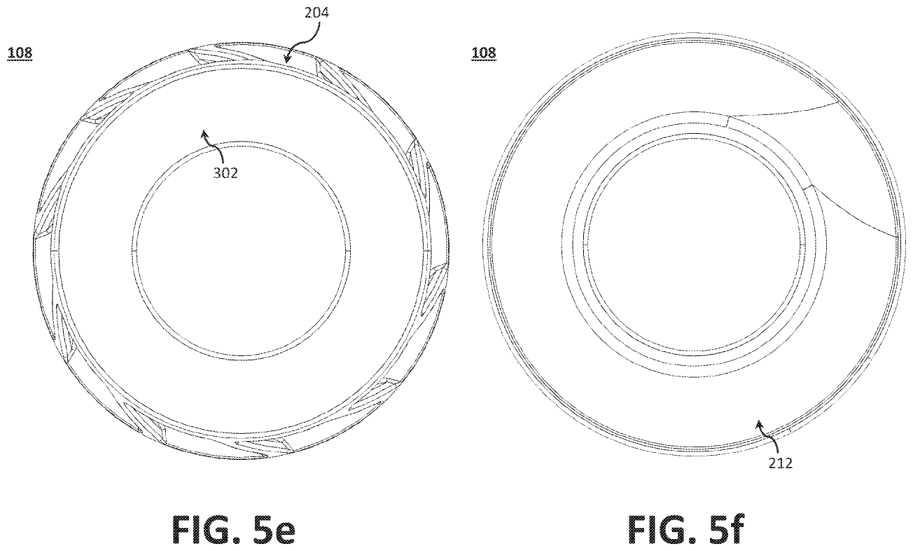

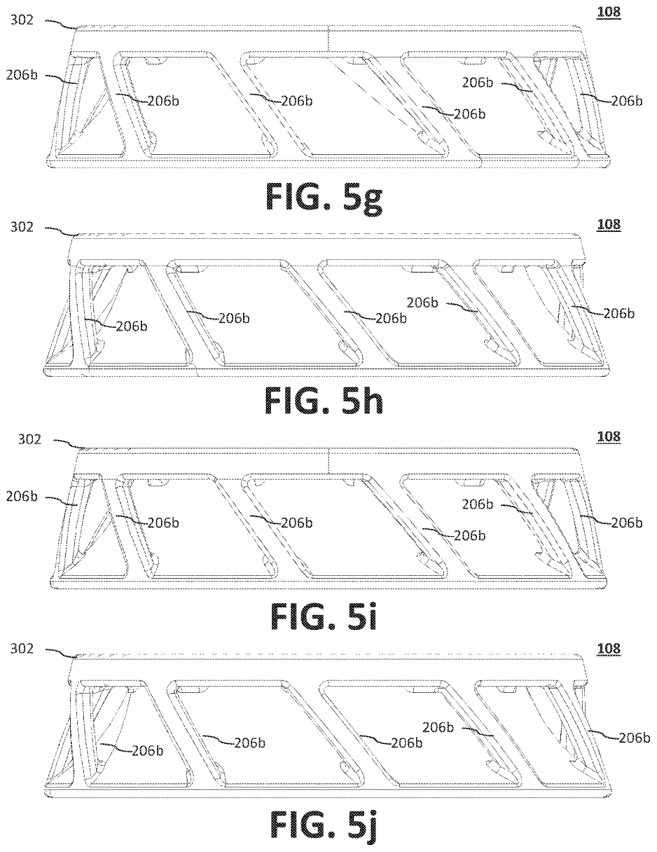

FIG. 5a illustrates an isometric view of the fastener assembly 100 in accordance with a fourth example, while FIG. 5b illustrates a cross-sectional side view thereof taken along cutline D-D (FIG. 5a). FIGS. 5c and 5d illustrate, respectively, topside and underside isometric views of the flexible seal 108 of FIG. 5a. FIGS. 5e and 5f illustrate, respectively, top and bottom plan views of the flexible seal 108. FIGS. 5g through 5j illustrate, respectively, first, second, third, and fourth side elevation views of the flexible seal 108 of FIG. 5a.

The flexible seal 108 according to the fourth example of FIGS. 5a through 5j is similar to the flexible seal 108 according to the second example of FIGS. 3a through 3j with a few exceptions. First, like the third example of FIGS. 4a through 4j, the plurality of generally vertical struts 206b are flared outwardly from the center axis 110 such that the outer diameter of the annular structure 202 is slightly larger than the head portion 106a, thus enhancing the seal by increasing the surface area contact between the annular structure 202 and the second panel 104. Second, the plurality of generally vertical struts 206b are substantially parallel to one another. Third, the generally horizontal struts 206b are omitted in favor of a solid annular panel 302. Finally, the plurality of generally vertical struts 206b are distributed evenly around the circumference and arranged at about 40 to 50 degrees relative to solid annular panel 302.

The seals 108 described herein can be manufactured from soft materials, such as those listed above, using additive manufacturing techniques, whereas the fastener 106 can be manufactured from rigid materials via a plastic injection process, additive manufacturing techniques, or otherwise.

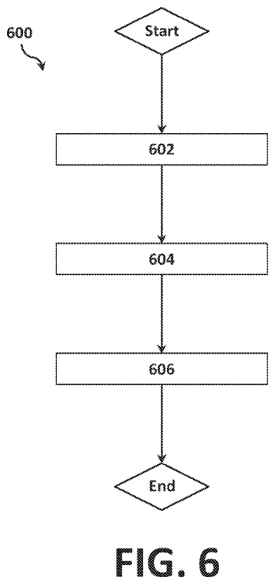

FIG. 6 illustrates an example method 600 of manufacturing and assembling the fastener assembly 100.

At step 602, the fastener 106 is manufactured from a rigid material. In some examples, the fastener 106 is manufactured via a plastic injection process, additive manufacturing techniques, or otherwise.

At step 604, the flexible seal 108 is manufactured from a soft material using an additive manufacturing techniques. For example, a 3D model of the flexible seal 108 is generated using computer-aided design (CAD) software. The 3D model specifies the size and shape of the flexible seal 108, including the intricacies of the lattice structure 204. The 3D model can be loaded to a 3D printer for processing by the 3D printer. In some examples, the 3D model can then be converted into a digital file format specific to the 3D printer, such as STL (stereolithography) and OBJ formats. The 3D printer, based on the 3D model, manufactured/builds the flexible seal 108 layer by layer.

At step 606, the flexible seal 108 is coupled to the fastener 106. For example, the flexible seal 108 can be slipped over the retention portion 106b and slid into place to abut a portion of the head portion 106a.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A flexible seal (108) to form a sealed connection between a first component (102) and a second component (104) via a fastener (106) and an opening (118) formed in the second component (104), the flexible seal (108) comprising:
a through-hole (210) configured to receive at least a portion of the fastener (106);
a seal surface (212) configured to conform to the second component (104) and to seal the opening (118); and
a lattice structure (204) configured to manage a seal formed between the seal surface (212) and the second component (104).

2. The flexible seal (108) of claim 1, wherein the lattice structure (204) comprises a plurality of struts (206).

3. The flexible seal (108) of claim 2, wherein each of the plurality of struts (206) is linear and resides in a single plane.

4. The flexible seal (108) of claim 1, wherein the lattice structure (204) comprises a first plurality of struts (206a) that resides in a single plane and a second plurality of struts (206b), wherein each of the second plurality of struts (206b) is transverse to the single plane.

5. The flexible seal (108) of claim 4, wherein the second plurality of struts (206b) are arranged at an outer circumference of the flexible seal (108) and configured to manage compressive loads of the flexible seal (108).

6. The flexible seal (108) of claim 4, wherein the second plurality of struts (206b) are arranged to define a truss.

7. The flexible seal (108) of claim 1, wherein the lattice structure (204) comprises a plurality of struts (206) arranged at an outer circumference of the flexible seal (108) and configured to manage compressive loads of the flexible seal (108).

8. The flexible seal (108) of claim 1, wherein the lattice structure (204) is formed on a surface opposite the seal surface (212).

9. The flexible seal (108) of claim 1, wherein the seal surface (212) is a generally concave seal surface.

10. The flexible seal (108) of claim 1, wherein the flexible seal (108) is an annular structure (202).

11. A fastener assembly (100) to form a sealed connection between a first component (102) and a second component (104) having an opening (118), the fastener assembly (100) comprising:
a fastener (106) configured to retain the second component (104) relative to the first component (102); and
a flexible seal (108) configured to couple to the fastener (106), wherein the flexible seal (108) comprises a through-hole (210), a lattice structure (204), and a seal surface (212) configured to conform to the second component 104 and to seal the opening (118).

12. The fastener assembly (100) of claim 11, wherein the lattice structure (204) comprises a plurality of struts (206).

13. The fastener assembly (100) of claim 12, wherein each of the plurality of struts (206) is linear and resides in a single plane.

14. The fastener assembly (100) of claim 12, wherein the plurality of struts (206) includes a first plurality of struts (206a) that resides in a single plane and a second plurality of struts (206b), wherein each of the second plurality of struts (206b) is transverse to the single plane.

15. The fastener assembly (100) of claim 14, wherein the second plurality of struts (206b) are arranged at an outer circumference of the flexible seal (108) and configured to manage compressive loads of the flexible seal (108).

16. The fastener assembly (100) of claim 14, wherein the second plurality of struts (206b) are arranged to define a truss.

17. The fastener assembly (100) of claim 11, wherein the lattice structure (204) comprises a plurality of struts (206) arranged at an outer circumference of the flexible seal (108) and configured to manage compressive loads of the flexible seal (108).

18. A method of fabricating a flexible seal (108) to form a sealed connection between a first component (102) and a second component (104) via a fastener (106) and an opening (118) formed in the second component (104), the method comprising:
loading a 3D model to a 3D printer for processing by the 3D printer,
wherein the 3D model specifies the flexible seal (108) as having a through-hole (210) configured to receive at least a portion of the fastener (106), a seal surface (212) configured to conform to the second component 104 and to seal the opening (118), and a lattice structure (204) configured to manage a seal formed between the seal surface (212) and the second component (104); and
manufacturing, via the 3D printer based on the 3D model, a flexible seal (108) using a thermoplastic elastomer (TPE), a thermoplastic vulcanisate (TPV), or a thermoplastic polyurethane (TPU).

19. The method of claim 18, wherein the lattice structure (204) includes a first plurality of struts (206a) that resides in a single plane and a second plurality of struts (206b), wherein each of the second plurality of struts (206b) is transverse to the single plane.

20. A flexible seal (108) fabricated in accordance with the method of claim 18.
